(19) United States
(12) Patent Application Publication
(10) Pub. No.: US 2017/0215002 A1
(43) Pub. Date: Jul. 27, 2017

(54) ACOUSTIC APPARATUS

(71) Applicant: WOOX INNOVATIONS BELGIUM NV, Leuven (BE)

(72) Inventors: Roel REUSENS, Leuven (BE); Wil WAGENAARS, Leuven (BE)

(21) Appl. No.: 15/328,237

(22) PCT Filed: Jul. 21, 2014
(86) PCT No.: PCT/EP2014/065631

§ 371 Date: Jan. 23, 2017

(51) Int. Cl. H04R 1/34; H04S 7/00; H04S 3/00

(52) U.S. Cl. CPC H04R 1/345; H04S 3/008; H04S 7/30; H04R 2203/12; H04S 2400/01

(57) ABSTRACT

An acoustic apparatus comprising an acoustic generator generating audio output, with at least a portion of the audio output being at a high frequency and concentrated along a beaming axis. The acoustic apparatus has a device reference axis on which the acoustic generator is located on which the acoustic generator is located, and an acoustic reflector positioned to reflect at least a portion of the audio output such that the high frequency audio output is concentrated at a predetermined angle away from the device reference axis after being reflected. Also described is an acoustic system comprising two or more of the acoustic apparatuses.

The present invention relates generally to acoustic apparatus and systems, and in particular, acoustic apparatus systems for generating and reflecting audio output. The present invention is described herein primarily in relation to acoustic apparatus and systems for generating cinematic sound, but is not limited to this particular application.

### BACKGROUND

In most audio applications, a well-controlled distribution of sound energy is a prerequisite for a satisfying sound experience. This applies in the cases of stereo music listening, multi-channel movie watching and listening, and even in a cinema where cinemagoers are immersed in sound.

In the latter case, sound seems to come from everywhere due to a balanced sound mix and a sophisticated sound reproduction system, usually resulting in an impressive sound experience. Trying to recreate a similar experience in a living room is difficult, if not impossible, but the consumer electronics industry is continuously trying to come as close as possible to achieving this aim. Systems that try to achieve this aim include home theatre systems with five or more loudspeakers, combined with a subwoofer.

For a sound reproduction system, it is important to create a natural sound stage. Such a sound stage can contain information in the horizontal plane (e.g. stereo) and/or in the vertical plane (height). The width and natural quality of the sound stage will be improved by good separation of the different audio channels. For example, audio systems with discrete, separated loudspeakers in a well-defined speaker set-up can create such a natural sound stage.

However, many people want a simple sound system that is easy to install, without the cable clutter that typically comes with the more extended sound systems. For home theatre systems, this has resulted in products such as sound bars, and more recently, sound plates where the TV is placed on top of the product. In order to create an even wider sound field with these products, several techniques have been developed, from fairly simple techniques such as mounting loudspeakers at an angle, to using basic sound processing (e.g. a virtualizer), to more complex processing such as loudspeaker arrays in combination with sophisticated sound processing in order to create well-defined sound beams.

Furthermore, small portable loudspeakers are becoming more and more popular, especially with the rise of Bluetooth-enabled devices. Most of these loudspeakers are stereo devices, but due to the small form factor, the stereo imaging is as good as non-existent. A better separation of the left and right sound signals would be beneficial for stereo reproduction, preferably without complex sound processing for cost-saving and battery-efficiency reasons.

It is an object of the present invention to overcome or ameliorate at least one of the disadvantages of the prior art, or to provide a useful alternative.

### GENERAL

The present invention, in a first aspect, provides an acoustic apparatus comprising:
an acoustic generator generating audio output, at least a portion of the audio output being at a high frequency and concentrated along a beaming axis;
a device reference axis on which the acoustic generator is located; and
an acoustic reflector positioned to reflect at least a portion of the audio output such that the high frequency audio output is concentrated at a predetermined angle away from the device reference axis after being reflected.

In a second aspect, the present invention provides an acoustic system comprising two or more of the acoustic apparatuses described above.

Further features of various embodiments of the present invention are defined in the appended claims. It will be appreciated that the features above may be combined in various combinations in various embodiments of the present invention.

Throughout this specification, including the claims, the words “comprise”, “comprising”, and other like terms are to be construed in an inclusive sense, that is, in the sense of “including, but not limited to”, and not in an exclusive or exhaustive sense, unless explicitly stated otherwise or the context clearly requires otherwise.

### BRIEF DESCRIPTION OF THE FIGURES

Preferred embodiments in accordance with the best mode of the present invention will now be described, by way of example only, with reference to the accompanying figures, in which:

FIG. 1 is a schematic diagram of an acoustic apparatus in accordance with an embodiment of the present invention;

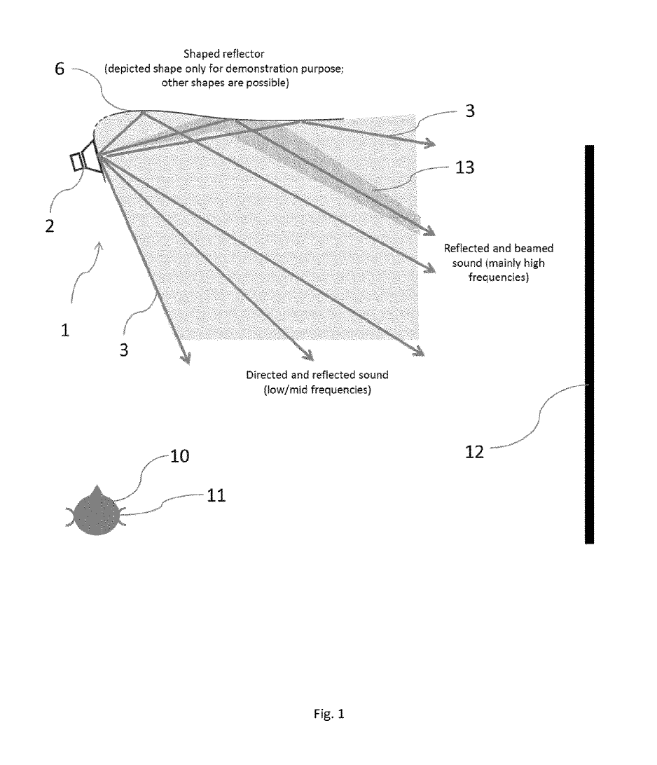

FIG. 2 is a schematic diagram of an acoustic apparatus in accordance with another embodiment of the present invention;

FIG. 3 is a schematic diagram of an acoustic apparatus in accordance with a further embodiment of the present invention;

FIG. 4 is a graph depicting the sound radiation pattern of a loudspeaker;

FIG. 5 is a graph depicting the sound radiation pattern of an acoustic apparatus in accordance with an embodiment of the present invention;

FIG. 6 is a schematic diagram of an acoustic apparatus in accordance with an embodiment of the present invention; and

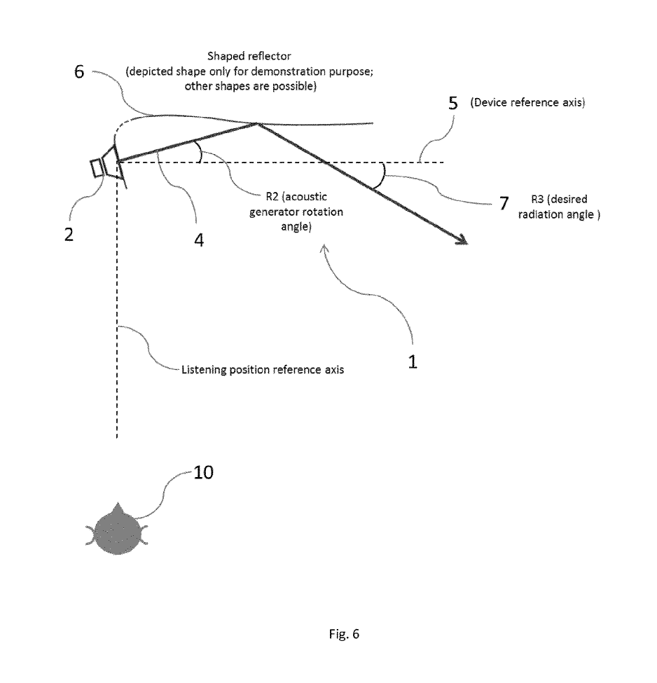

FIG. 7 is a schematic diagram of an acoustic apparatus in accordance with another embodiment of the present invention.

### DETAILED DESCRIPTION

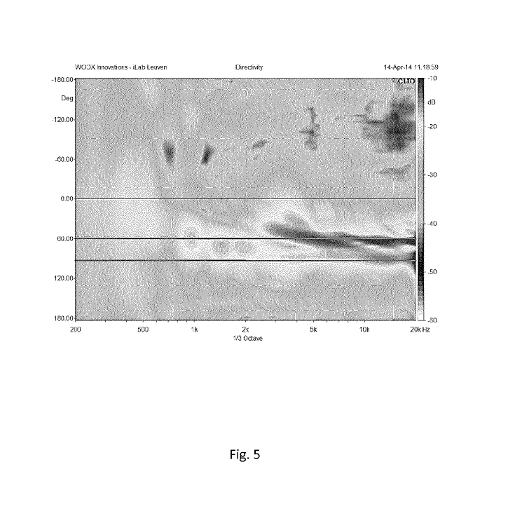

Referring to the figures, an acoustic apparatus 1 comprises an acoustic generator 2 generating audio output 3. At least a portion of the audio output 3 is at a high frequency and concentrated along a beaming axis 4. In typical embodiments, the audio output 3 at least containes mid, high, or both frequencies, with the high frequency portion of the audio output 3 mainly concentrated along the beaming axis 4, while the mid frequency portion of the audio output 3 has a wider radiation angle with respect to beaming axis 4. The acoustic apparatus 1 has a device reference axis 5 on which the acoustic generator 2 is located. The acoustic apparatus 1 further comprises an acoustic reflector 6 positioned to reflect at least a portion of the audio output such that the high frequency audio output is concentrated or substantially concentrated at a predetermined angle 7 away from the device reference axis 5 after being reflected. FIG. 5 shows the sound radiation pattern of one embodiment of the acoustic apparatus 1. As can be seen from FIG. 5, the high frequency audio output is concentrated at an angle within a band of between about 60° to about 90° away from 0°, with 0° being perpendiculato the device reference axis 5. In the present embodiment, 0° represents a listener position reference axis which is perpendicular to the device reference axis 5. In other embodiments, the acoustic apparatus 1 concentrates the high frequency audio output at other angles.

Typically, the acoustic generator 2 is rotated such that the beaming axis 4 is angled with respect to the device reference axis 5.

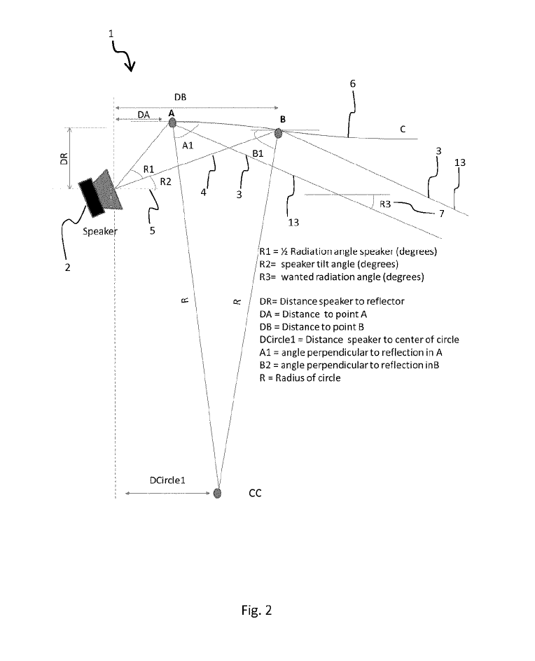

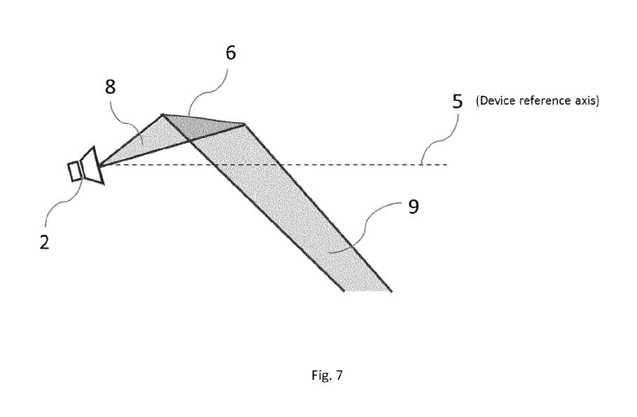

For example, as shown in FIG. 2, the beaming axis 4 is angled away from the device reference axis 5 by angle R2. In the present embodiment, the acoustic generator 2 is rotated such that the beaming axis 4 is angled away from the device reference axis 5 to a first side of the device reference axis and the portion 8 of the audio output 3 that is to be reflected is reflected back towards a second side of the device reference axis as reflected audio output 9. That is to say, the acoustic generator 2 is rotated such that the beaming axis 4 is angled away from the device reference axis 5 towards the acoustic reflector 6 and the portion of the audio output that is reflected is reflected back away from the acoustic reflector 6. As shown in FIG. 7, the combination of beaming axis 4 and the shape and position of acoustic reflector 6 determines the portion of the audio output 3 to be reflected 8, resulting in a reflected sound field 9.

The acoustic generator can be in the form of a loudspeaker, woofer, tweeter, or any other device that generates sound energy.

Typically, the acoustic reflector 6 reflects the portion of the audio output 3 towards a side 11 of the listening position 10. This includes where the acoustic reflector 6 reflects the portion of the audio output 3 directly towards the side 11 of the listening position, but this can also include where the acoustic reflector 6 reflects the portion of the audio output towards a wall 12 located to the side of the listening position 10, with the wall then reflecting the portion of the audio output towards the side 11 of the listening position 10.

In some embodiments, such as that shown in FIG. 2, the acoustic reflector 6 reflects the portion of the audio output 3 into focussed beams 13.

The acoustic reflector 6 is curved, and can follow a simple curve or a complex curve. The acoustic apparatus 1 can also have two or more of the acoustic reflectors 6, with each positioned to reflect a respective portion of the audio output 3 such that the high frequency audio output is concentrated or substantially concentrated at a predetermined angle away 7 from the device reference axis 5 after being reflected.

In other embodiments, the present invention also provides an acoustic system 14 comprising two or more of the acoustic apparatus 1 described above.

In some embodiments, each acoustic generator 2, corresponding to a respective acoustic apparatus 1, generates audio output corresponding to a respective stereo channel. For example, in some embodiments, the audio output corresponds to a left stereo channel and a right stereo channel. However, in other embodiments, the audio output generated by each acoustic generator can correspond to a 5.1 or 7.1 stereo channel. In other words, the audio output generated by each acoustic generator can correspond to one of the six stereo channels of a 5.1 stereo audio output. Alternatively, the audio output generated by each acoustic generator can correspond to one of the eight stereo channels of a 7.1 stereo audio output.

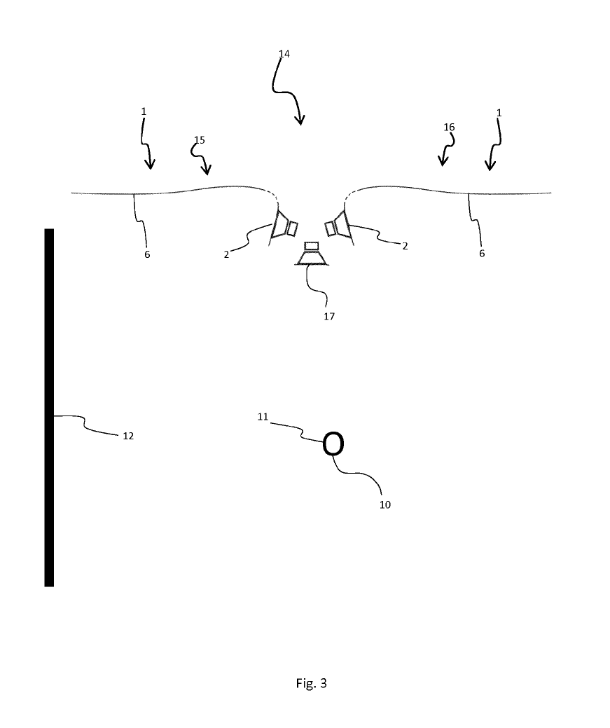

In one embodiment, as shown in FIG. 3, the acoustic system 14 comprises two of the acoustic apparatuses 1, namely, a left acoustic apparatus 15 and a right acoustic apparatus 16. The acoustic system 14 further comprises a front-facing acoustic generator 17. The front-facing acoustic generator 17 beams audio output towards a listening position 10, with the listening position 10 directly in front of the front-facing acoustic generator 17. Looking towards the front of the front-facing acoustic generator 17, the acoustic generator 2 of the left acoustic apparatus 15 is located to a left side of the front-facing acoustic generator 17 and beams left channel stereo audio output towards the left. The acoustic generator 2 of the right acoustic apparatus 16 is located to a right side of the front-facing acoustic generator 17 and beams right channel stereo audio output towards the right. The front-facing acoustic generator 17, and the acoustic generators 2 of the left and right acoustic apparatuses can be housed in the same speaker housing.

The acoustic generators 2 of the left and right acoustic apparatuses 15 and 16 are rotated so that each faces towards the back under a certain angle, away from the front, that is, away from the direction in which the front-facing acoustic generator 17 faces. The acoustic reflectors 6 of the left and right acoustic apparatuses 15 and 16 are located further towards the back so that the backwards facing acoustic generators 2 of the left and right acoustic apparatuses 15 and 16 beam audio output to respective acoustic reflectors. Audio output is then reflected by the acoustic reflectors 6 to either side of the listening position 10. In some embodiments, this reflected audio output is also directed towards side walls located to either side of the listening position 10. The audio output is then reflected off the side walls towards the sides of the listening position.

In the embodiment shown in FIG. 3, the acoustic generators 2 of the left and right acoustic apparatuses 15 and 16 share a common device reference axis 5. Each of the acoustic generators 2 is rotated towards the back under a certain angle so that the respective beaming axis 4 forms an acute angle with the device reference axis 5.

In this way, the left and right channel stereo audio outputs create a wider sound stage. This is achieved even though the acoustic generators 2 of the left and right acoustic apparatuses 15 and 16 are located closely adjacent the front-facing acoustic generator 17 in a central position opposite the listening position 10.

In one embodiment, the left and right acoustic apparatuses 15 and 16 and the front-facing acoustic generator 17 are housed in the same housing. The acoustic reflectors 6 need not be connected to the respective acoustic generators 2, and typically, are separate components to the acoustic generators 2. The dotted lines in FIG. 3 indicate this separation.

The shape of each acoustic reflector 6 is designed in such a way that the natural directivity behaviour of the acoustic generator 2 (that is, less directivity at low frequencies, ka<1, but more directivity at higher frequencies, ka>1) in combination with the acoustic reflector 6 results in the desired frequency distribution, that is, the high frequencies are beamed under a well-defined angle (or angles), while the low/mid frequencies are reflected over a wider opening angle. High frequencies are typically frequencies 1000 Hz or above.

In some embodiments, the angle of the beam is defined in such a way that high frequencies are reflected to the listener by the side walls 12 of a listening room. Since the high frequencies are an important cue for spatial perception, being able to control their radiation angle provides a powerful means to create a wide sound stage.

As described above, when combining two acoustic apparatuses 1, each with a combination of an acoustic generator 2 and an acoustic reflector 6, in a left and right (e.g. left and right stereo channels) set-up, much improved acoustic channel separation will be achieved.

Different acoustic reflector shapes are possible, depending on the desired frequency distribution. There are many ways to calculate the exact shape of the acoustic reflector 6. Referring to the example shown in FIG. 2, the acoustic reflector 6 is formed from the arcs of circles. However, other curve incarnations and shapes (e.g. with a single curve, with multiple curve orientations, or part of an ellipse) are possible.

The labels used in FIG. 2 have the following meanings:

R1=desired radiation angle of the audio output from the acoustic generator 2 to be reflected;

R2=the rotation angle, that is, the angle between the beaming axis 4 and the device reference axis 5;

R3=the predetermined angle 7, that is, the desired radiation angle with respect to the device reference axis;

DR =the perpendicular distance between the device reference axis and Point A on the acoustic reflector 6;

DA=the perpendicular distance between the centre of the front of the acoustic generator 2 and Point A on the acoustic reflector 6;

DB=the perpendicular distance between the centre of the front of the acoustic generator 2 and Point B on the acoustic reflector 6;

DCircle1=the perpendicular distance between the centre of the front of the acoustic generator 2 and the centre of the circle CC whose arc forms the portion from Point A to Point B on the acoustic reflector 6; and

R=the radius of circle CC.

If R1, R2, R3, and DR are known (predetermined), then the other variables can be calculated as follows:

A1=90°−(R2)/2−(R1)/2+(R3)/2

DA=DR/tan (R1+R2)

B1=90°+(R2)/2−(R3)/2

DB=DR/tan (R2)

R=(DB−DA)/(cos (B1)+cos (B2))

DCircle1=DA+(cos (A1)*R)

With embodiments of the present invention, a natural, wide sound stage can be created in a simple, straight-forward manner by beaming mainly high frequency audio output towards a certain, well-defined direction while maintaining a more omnidirectional behaviour for the low/mid frequencies (typically less than 1000 Hz).

Embodiments of the present invention make use of the natural directivity behaviour of a loudspeaker or other acoustic generator (less directive at lower frequencies, more directive at higher frequencies) in combination with a specially curved acoustic reflector to beam mainly high frequencies at a desired angle, and to reflect low/mid frequencies over a wider opening angle.

With two acoustic apparatuses 1 (even with the respective acoustic generators 2 mounted close to each other), an enhanced stereo effect can be obtained. Except for some basic equalization, neither further sound processing or a loudspeaker array is required to create a wide sound stage for an immersive sound experience, or better stereo separation for small devices.

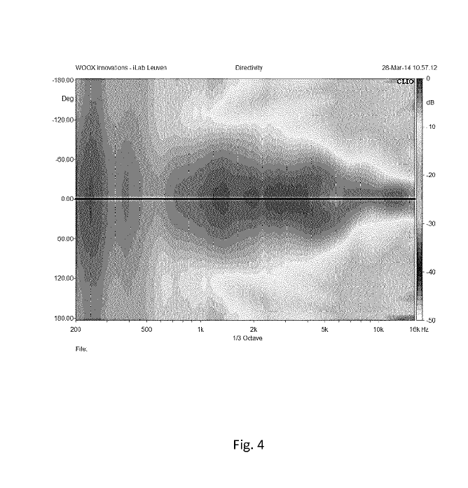

FIG. 4 shows a typical radiation pattern of a 2″ loudspeaker (acoustic generator) in a small box. As FIG. 4 demonstrates, the radiation pattern of the loudspeaker is concentrated around 0°, with the pattern being omni-directional at low frequencies and becoming narrower at higher frequencies.

FIG. 5 shows the radiation pattern of the same 2″ loudspeaker in combination with an acoustic reflector to form the acoustic apparatus 1 in accordance with embodiments of the present invention. The desired radiation angles were defined at 60° and 90° with respect to the listener position reference axis, which is perpendicular (or 90°) to the device reference axis 5. These directivity angles and beam width are completely determined by the directivity pattern of the loudspeaker (acoustic generator) 2, the angle between the loudspeaker 2 and the acoustic reflector 6, and the shape of the curved acoustic reflector 6, in accordance with embodiments of the present invention.

Acoustic reflectors 6 can be made from different materials, whereby the material properties can be chosen as a parameter to further influence the desired sound radiation pattern. The surface structure can also be used as a design parameter to achieve the desired radiation pattern.

In summary, the advantages of embodiments of the present invention over other sound beaming solutions include:
wide, natural sound stage reproduction;
improved stereo separation; and
no requirement for sophisticated sound processing.

Embodiments of the present invention can be used for a wide range of audio applications where there is need for a wide sound stage, good stereo separation, or a well-defined sound radiation pattern. Examples of suitable applications include:
sound bars with wider sound images;
portable loudspeakers with increased stereo imaging;
home cinema systems to create a wide horizontal and vertical sound stage; and
home audio systems with improved stereo effect.

It can be appreciated that the aforesaid embodiments are only exemplary embodiments adopted to describe the principles of the present invention, and the present invention is not merely limited thereto. Various variants and modifications may be made by those of ordinary skill in the art without departing from the spirit and essence of the present invention, and these variants and modifications are also covered within the scope of the present invention. Accordingly, although the invention has been described with reference to specific examples, it can be appreciated by those skilled in the art that the invention can be embodied in many other forms. It can also be appreciated by those skilled in the art that the features of the various examples described can be combined in other combinations.

1. An acoustic apparatus comprising:
an acoustic generator generating audio output, at least a portion of the audio output being at a high frequency and concentrated along a beaming axis;
a device reference axis on which the acoustic generator is located; and
an acoustic reflector positioned to reflect at least a portion of the audio output such that the high frequency audio output is concentrated at a predetermined angle away from the device reference axis after being reflected.

2. An acoustic apparatus according to claim 1 wherein the acoustic generator is rotated such that the beaming axis is angled away from the device reference axis.

3. An acoustic apparatus according to claim 1 wherein the acoustic generator is rotated such that the beaming axis is angled away from the device reference axis towards the acoustic reflector and the portion of the audio output that is reflected is reflected back away from the acoustic reflector.

4. An acoustic apparatus according to claim 1 wherein the acoustic reflector reflects the portion of the audio output towards a side of the listening position.

5. An acoustic apparatus according to claim 4 wherein the acoustic reflector reflects the portion of the audio output towards a wall located to the side of the listening position, the wall then reflecting the portion of the audio output towards the side of the listening position.

6. An acoustic apparatus according to claim 1 wherein the acoustic reflector reflects the portion of the audio output into focussed beams.

7. An acoustic apparatus according to claim 1 wherein the acoustic reflector is curved.

8. An acoustic apparatus according to claim 1 wherein the acoustic reflector is a complex curve.

9. An acoustic apparatus according to claim 1 further comprising two or more of the acoustic reflectors, each positioned to reflect a respective portion of the audio output such that the high frequency audio output is concentrated at a predetermined angle away from the device reference axis after being reflected.

10. An acoustic system comprising two or more of the acoustic apparatuses according to claim 1.

11. An acoustic system according to claim 10 wherein each acoustic generator, corresponding to a respective acoustic apparatus, generates audio output corresponding to a respective stereo channel.

12. An acoustic system according to claim 10 comprising a left and a right acoustic apparatus according to claim 1, and a front-facing acoustic generator, the front-facing acoustic generator beaming audio output towards a listening position, the acoustic generator of the left acoustic apparatus located to a left side of the front-facing acoustic generator and beaming left channel audio output towards the left, the acoustic generator of the right acoustic apparatus located to a right side of the front-facing acoustic generator and beaming right channel audio output towards the right.

13. An acoustic system according to claim 12 wherein the left and right acoustic apparatuses and the front-facing acoustic generator are housed in a housing.
